(19) United States
(12) Patent Application Publication
(10) Pub. No.: US 2025/0073624 A1
(43) Pub. Date: Mar. 6, 2025

(54) In-mold piping filter

(71) Applicant: JUN HE TECHNOLOGY CO., LTD., CHANGHUA COUNTY (TW)

(72) Inventor: CHIANG-CHUAN WANG, FUXING TOWNSHIP (TW)

(21) Appl. No.: 18/242,331

(22) Filed: Sep. 5, 2023

(51) Int. Cl. B01D 35/02; B01D 29/01; B01D 29/03

(52) U.S. Cl. CPC B01D 35/023; B01D 29/012; B01D 29/03

(57) ABSTRACT

An in-mold piping filter includes: a join made by plastic injection molding and having a tubular body. Two ends of the tubular body are respectively formed with the opening, and the two openings provide a connection, so that a complete pipeline is constructed and fluid can be transported through the joint. Moreover, the filter member is integrally formed inside the tubular body during the injection molding, and the filter member includes a dividing plate. The dividing plate has a plurality of filter holes.

### BACKGROUND OF INVENTION

### Field of Invention

The present invention relates to an in-mold piping filter.

### Description of Related Art

Typically, the pipe joint installed between the water equipment and the water pipeline, as shown in FIG. 10 and FIG. 11, includes: a joint body 20 and a filter member 30. The joint body 20 has two the openings 21, so that water can enter from one of the opening 21, pass through the joint body 20, and leave from the other the opening 21. Then, the joint body 20 is connected with the water pipeline to obtain water supply. A stepped edge 22 or a ring ditch is provided in the opening 21 for accepting the filter member 30 to be installed, or the filter member 30 is installed at the ring ditch. The filter member 30 is a filter with a plurality of filtering holes 31. When filter member 30 is installed at one of the openings 21 of the joint body 20 is inside, the filter holes 31 can be used to filter the water flowing through the filter member 30 to prevent the impurities in the water from flowing into the water equipment together with the water flow.

However, the conventional structure above still has the following problems in practical application: first, the joint has many internal parts, and it takes additional time and effort to assemble the filter member 30, which increases the production cost; second, the filter member 30 is a very small size component, so it is difficult to handle during installation; third, after the filter member 30 is placed in the opening 21, it needs to be pressed into a ring groove, or bonded with high frequency, which will greatly increase the man-hour and assembly complexity.

Therefore, it is desirable to provide an in-mold piping filter to mitigate and/or obviate the aforementioned problems.

### SUMMARY OF THE INVENTION

An objective of the present invention is to provide an in-mold piping filter providing easier manufacture.

In order to achieve the above mentioned objective, an in-mold piping filter includes: a join made by plastic injection molding and having a tubular body. Two ends of the tubular body are respectively formed with the opening, and the two openings provide a connection, so that a complete pipeline is constructed and fluid can be transported through the joint. Moreover, the filter member is integrally formed inside the tubular body during the injection molding, and the filter member includes a dividing plate. The dividing plate has a plurality of filter holes.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment according to the present invention.

FIG. 2 is a three-dimensional partial sectional view of the preferred embodiment according to the present invention.

FIG. 3 is a plan view of the preferred embodiment according to the present invention.

FIG. 4 is a schematic drawing of the injection molding process of the present invention.

FIG. 5 is another schematic drawing of the injection molding process of the present invention.

FIG. 6 is another schematic drawing of the injection molding process of the present invention.

FIG. 7 shows the mold opening after the in-mold piping filter being finished according to the present invention

FIG. 8 shows the filter member filtering fluid in the joint according to the present invention.

FIG. 9 shows the filter member filtering fluid in the joint from a different input direction according to the present invention.

FIG. 10 is a three-dimensional exploded view of a conventional structure.

FIG. 11 is a cross-sectional view of a combination of conventional structures.

### DESCRIPTION OF THE PREFERRED EMBODIMENT

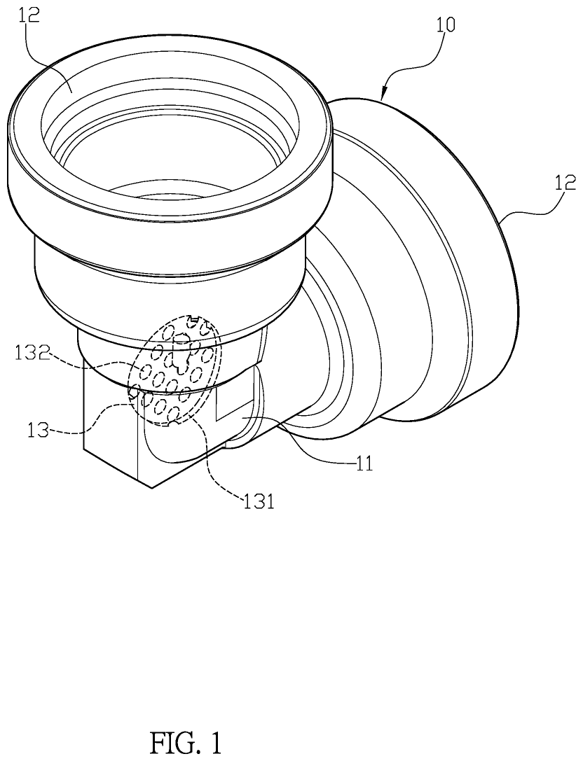

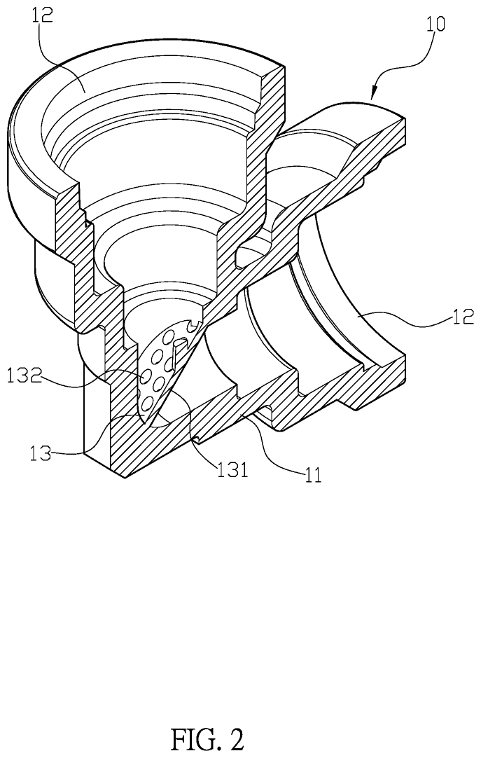

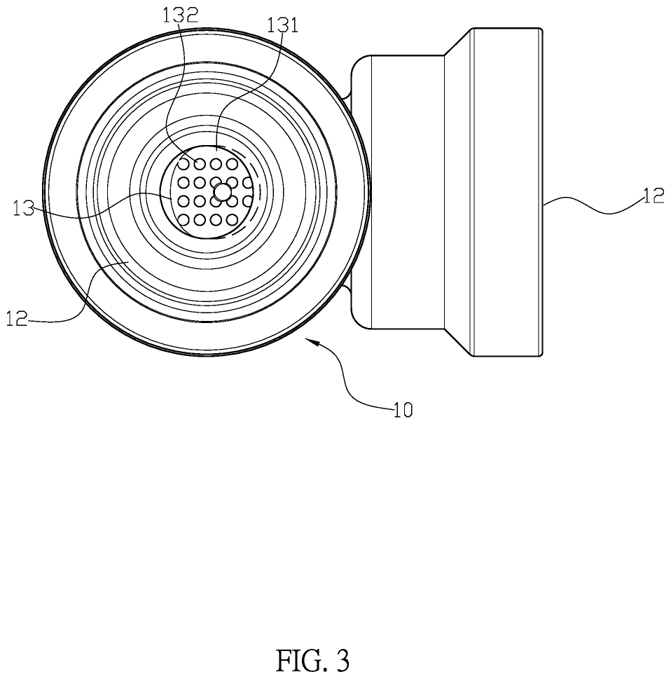

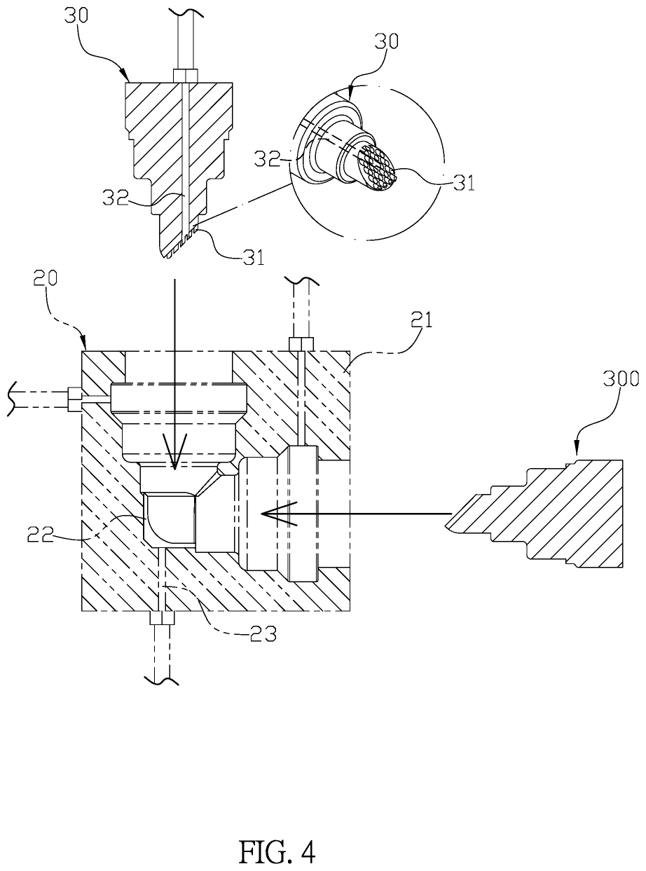

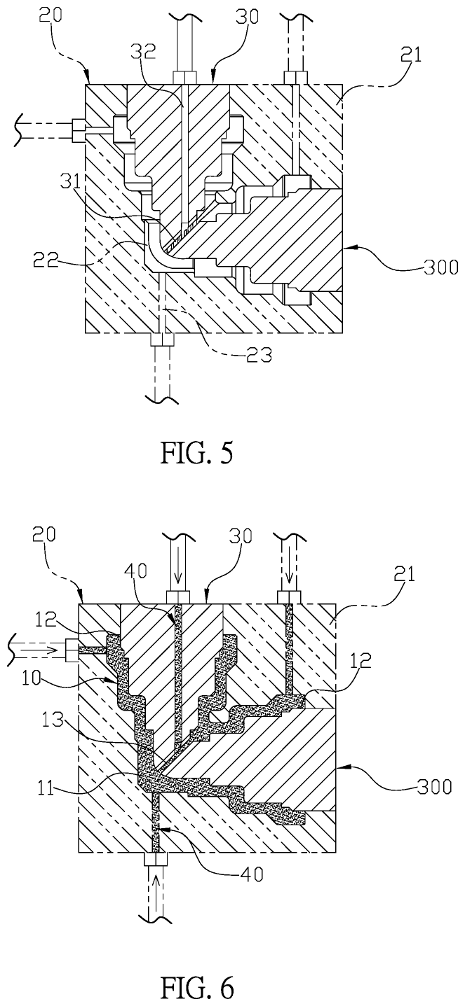

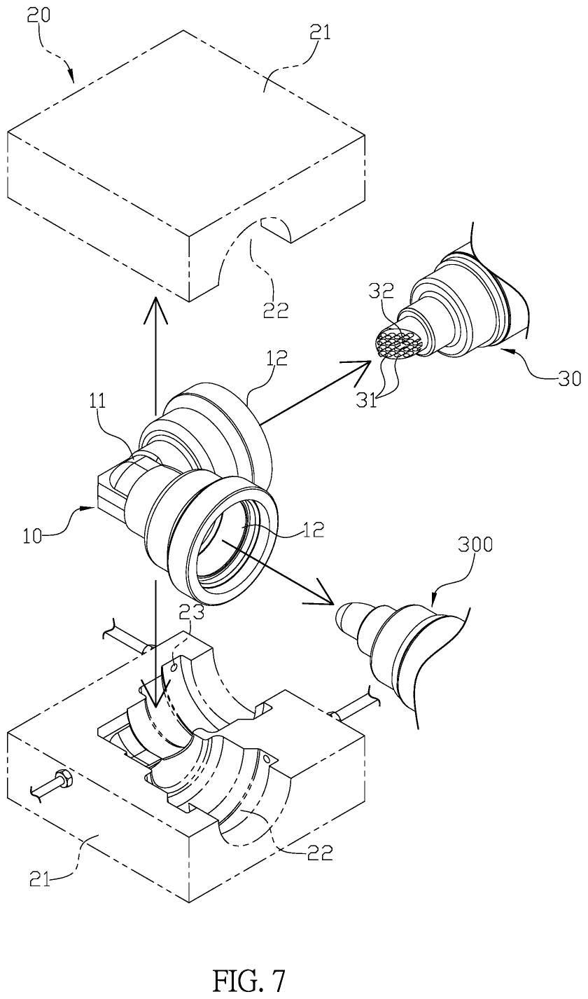

First, please refer to FIG. 1 and FIG. 7. An in-mold piping filter comprises a joint 10. The joint is made by melting plastic particles into a liquid plastic material 40 at high temperature, and then injecting the liquid plastic material 40 into a mold cavity 22 defined inside a mold 20, so that the joint 10 is integrally formed in the mold 20 and obtained by removal from the mold 20. The mold 20 further comprises a first slide insert 30 and a second slide insert 300 placed in the mold cavity 22 before the injection of the liquid plastic material 40, for forming the pipe filter in a tubular body 11. The joint 10 has the tubular body 11 and an opening 12 at each end of the tubular body 11 configured to allow fluid to pass therethrough. With the design of the mold 20, the first slide insert 30 and the second slide insert 300, the joint 10 has a filter member 13 inside the tubular body 11 comprising a dividing plate 131 comprising a plurality of filtering holes 132 and a peripheral edge of the partition plate 131 integrally connected with the inner wall of the tubular bod 11.

The mold 20 has two dies 21 each having a mold cavity 22 at corresponding inner sides, and when the two dies 21 are brought together, the first slide insert 30 and the second slide insert 300 are respectively placed from the two ends of the mold cavities 22. Furthermore, the mold 20 further has at least one injection port 23 for accepting the liquid plastic material 40. The first slide insert 30 and the second slide insert 300 are both smaller than the mold cavity 22 such that when the first slide insert 30 and the second slide insert 300 are placed in the mold cavity 22, a circular space is formed between an inner wall of the mold cavity 22, and the first slide insert 30 and the second slide insert 300 for forming the tubular body 11. An end of the first slide insert 30 has a plurality of columns 31 is inserted into the mold cavity 22 and abutting against an end of the second slide insert 300 in the mold cavity 22. Through the protrusions of these cylinders 31, the facing ends of the first slide insert 30 and the second slide insert 300 are moderately separated, and the liquid plastic material 40 can be injected to produce the tubular body 11 and the filter member 13 is integrally molded inside the tubular body 11, so that the joint 10 can be used directly without additional assembly of the filter member 13.

In addition, the tubular body 11 is a bent pipe.

Also, the tubular body 11 is a 90° elbow pipe.

Additionally, the filter member 13 is located at s middle section of the tubular body 11.

Furthermore, the filter member 13 is disposed in the tubular body 11 inclinedly.

Moreover, the mold cavity 22 is defined on two facing inner sides of the two dies 21.

Also, the first slide insert 30 further has at least one injection port 32 for accepting the liquid plastic material 40.

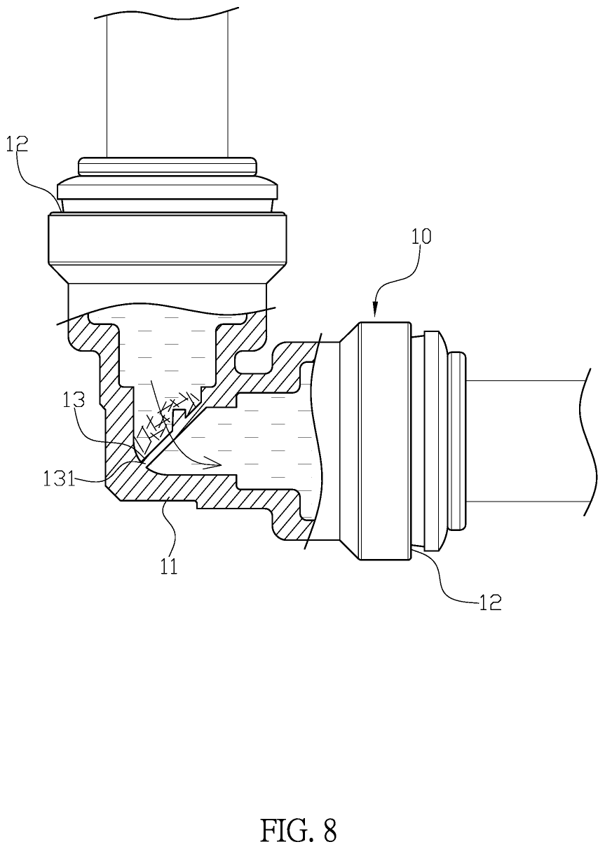

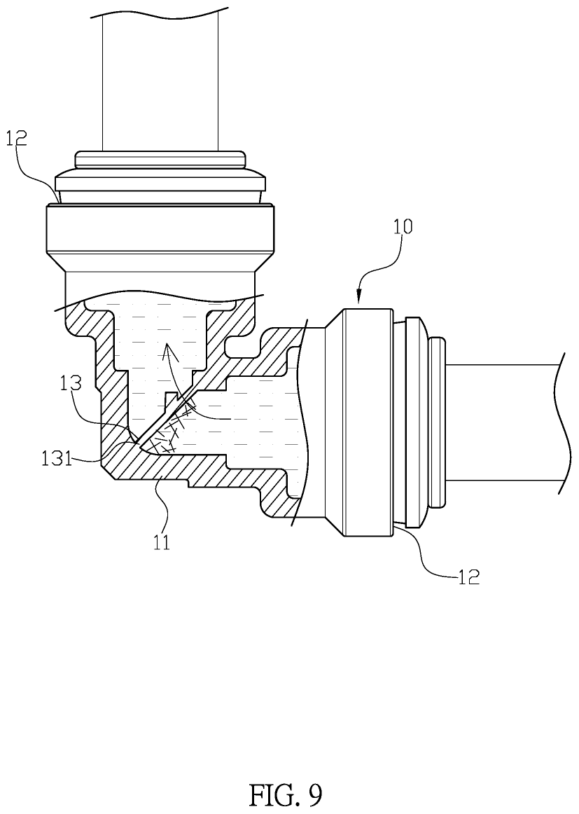

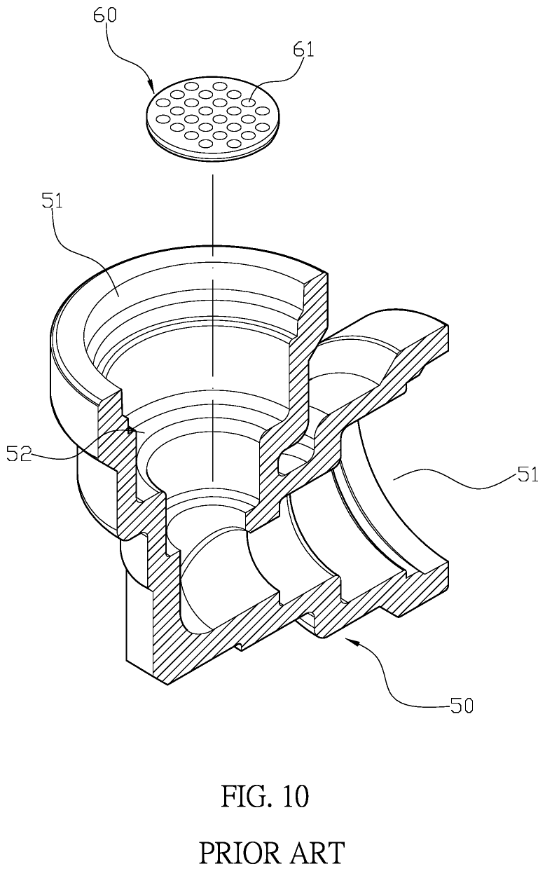

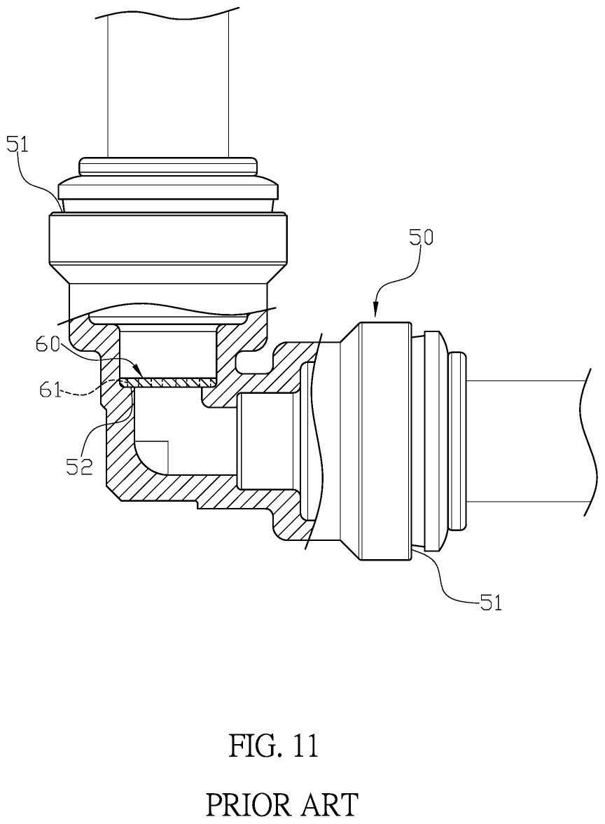

The above-mentioned in-mold piping filter has the following advantages: 1. the joint 10 and the filter member 13 are integrally formed, so that the filter member 13 does not need to be assembled, so that the production cost can be minimized; 2. the joint 10 and the filter member 13 are integrally formed, so there is no need to worry about the installation of the filter member 13; 3. the joints 10 and the filter member 13 are integrally formed so that the filter member 13 does not need to be attached to the joint 10, which shortens overall production time; and 4. the filter member 13 is integrally molded inside the tubular body 11 instead of on any one of the openings 12, so the use of the joint 10 is relatively free from direction restrictions and any one of the opening 12 can be used for water inlet or outlet (as shown in FIGS. 8 and 9).

Although the present invention has been explained in relation to its preferred embodiment, it is to be understood that many other possible modifications and variations can be made without departing from the spirit and scope of invention as hereinafter claimed.

What is claimed is:

1. An in-mold piping filter comprising a joint, wherein:
the joint is made by melting plastic particles into a liquid plastic material at high temperature, and then injecting the liquid plastic material into a mold cavity defined inside a mold, so that the joint is integrally formed in the mold and obtained by removal from the mold; wherein the joint has a tubular body and an opening at each end of the tubular body configured to allow fluid to pass therethrough; the joint has a filter member inside the tubular body comprising a dividing plate comprising a plurality of filtering holes and a peripheral edge of the partition plate integrally connected with the inner wall of the tubular body; the mold further comprises a first slide insert and a second slide insert for forming the pipe filter in the tubular body;
wherein the mold has two dies each having a mold cavity at corresponding inner sides, and when the two dies are brought together, the first slide insert and the second slide insert are respectively placed from the two ends of the mold cavities, and the mold further has at least one injection port for accepting the liquid plastic material; and
the first slide insert and the second slide insert are both smaller than the mold cavity such that when the first slide insert and the second slide insert are placed in the mold cavity, a circular space is formed between an inner wall of the mold cavity, the first slide insert and the second slide insert for forming the tubular body; an end of the first slide insert having a plurality of columns is inserted into the mold cavity and abutting against an end of the second slide insert in the mold cavity.

2. The in-mold piping filter as claimed in claim 1, wherein the tubular body is a bent pipe.

3. The in-mold piping filter as claimed in claim 2, wherein the tubular body is a 90° elbow pipe.

4. The in-mold piping filter as claimed in claim 1, wherein the filter member is located at a middle section of the tubular body.

5. The in-mold piping filter as claimed in claim 1, wherein the filter member is inclinedly disposed in the tubular body.

6. The in-mold piping filter as claimed in claim 1, wherein the mold cavity is defined on two facing inner sides of the two dies.

7. The in-mold piping filter as claimed in claim 1, wherein the first slide insert further has at least one injection port.
